(19) United States
(12) Patent Application Publication
(10) Pub. No.: US 2008/0229134 A1
(43) Pub. Date: Sep. 18, 2008

(54) RELIABILITY MORPH FOR A DUAL-CORE TRANSACTION-PROCESSING SYSTEM

(75) Inventors: Pradip Bose, Yorktown Heights, NY (US); Philip George Emma, Danbury, CT (US); Jude A. Rivers, Cortlandt Manor, NY (US); Sumedh Wasudeo Sathaye, Austin, TX (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/684,987

(22) Filed: Mar. 12, 2007

(51) Int. Cl. G06F 15/76

(52) U.S. Cl. 713/375

(57) ABSTRACT

In processors having buffers to manage instruction flow referred to as a ReOrder Buffer (ROB) it is shown that these buffers are of the same approximate size of a checkpoint array for architected state. In a particular “morphing mode” in which a pair of processors can be configured to provide different functionalities on demand, a new “High-Reliability” (HR) mode is provided in which the ROB of one of the processors is used for a checkpoint array, and the pair of processors is made to run in lockstep on a single instruction stream under the control of the remaining ROB so as to provide redundant, hence highly-reliable computing.

### STATEMENT REGARDING FEDERALLY SPONSORED RESEARCH OR DEVELOPMENT

This invention was made with Government support under Contract No.: NBCH3039004 awarded by DARPA. The Government has certain rights in this invention.

### FIELD OF THE INVENTION

The present disclosure relates to the field of reliable computing using processor-level redundancy.

### BACKGROUND OF THE INVENTION

U.S. Pat. No. 5,692,121 describes a system of two processors in which both processors run the same instruction stream in lockstep, and in which the results of every instruction are checkpointed in an ECC-hardened checkpoint register array. That patent describes an “R-Unit” which checks—in a highly reliable way—that both processors agree prior to checkpointing the results of each instruction.

The purpose of U.S. Pat. No. 5,692,121 is to provide highly reliable operation. The architected state of a processor comprises only that state that is visible to the “Instruction Set Architecture.” As long as the architected state can be reliably maintained, e.g., by using Error Control Codes (ECCs), if an error is found in the running pair of processors, they can be returned to a known good state by refreshing all of their working registers with these values. By the nature of how the R-Unit retires instructions, that state will be consistent with the (correct) state of the machine following the last successfully completed instruction.

That is, the R-Unit with its checkpointed state allows the processor to “rollback” to a known good point, and to restart the instruction stream from that point, thereby removing any manifestations of soft errors.

### BRIEF SUMMARY OF THE INVENTION

In a dual-processor system having a plurality of operating modes in which two independent processors can be conjoined into a single superscalar processor, a method and system for providing reliable computing are provided. In one aspect, the method includes using a reorder buffer of a first processor for a checkpoint array; using a reorder buffer of a second processor to keep track of a plurality of instructions; running the first processor and the second processor under control of the reorder buffer of the second processor; comparing output of the first processor and the second processor; if the output of the first processor and the second processor match, checkpointing the output in the reorder buffer of a first processor used as a checkpoint array; and if the output of the first processor and the second processor do not match, using one or more states in the reorder buffer of a first processor used as a checkpoint array to refresh one or more states in the first processor and the second processor.

A system for providing reliable computing in one aspect includes a reliability unit provided for a processor pair, the reliability unit including at least: a reorder buffer of a first processor in the processor pair operable for use as checkpoint array; a comparison logic operable to compare one or more results of every instruction completed by the processor pair; and an error control codes generation logic operable to generate error control code for the one or more results.

In one aspect, the object of this invention is to provide a new morphing mode for two processors, called “High Reliability” (HR) mode that conforms to the basic infrastructure of the “ReOrder Buffer” (ROB). This would allow a pair of processors to either run independently on two streams in TLP mode, or to run in lockstep on a single stream in HR mode. Or it would allow the pair of processors to run at very high performance on a single stream in ILP mode, or in lockstep on that same stream (albeit slower) in HR mode. Finally, it would allow the pair of processors to run in any of the modes: ILP, TLP, or HR, depending on what is desirable at any time.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows the ILP/TLP “morph.”

FIG. 2 shows a new “High-Reliability” molphing mode using the elements of FIG. 1 in one embodiment of the present disclosure.

### DETAILED DESCRIPTION

U.S. patent application Ser. No. ______ fled on ______ by Sumedh Sathaye entitled “Computer Porcessing System That Enables Multiple Processing Elements to Behave as a Single Processing Element” and assigned to the same assignee as the present application is incorporated herein by reference in its entirety. That application describes a “morphing” function in which two independent (perhaps supersealar) processors become conjoined into a single supersealar processor by adding a “Super ReOrder Buffer” (SROB) to the pair. The function of the SROB is to keep track of all of the instructions in flight.

In a first mode, the two processors run independently, providing service to two independent instruction streams, thereby providing high transaction throughput via “Transaction-Level Parallelism” (TLP). In a second mode, the two processors work together on a single instruction stream to provide very high performance on the single stream via “Instruction-Level Parallelism” (ILP). The pair can then be “morphed” between ILP mode and TLP mode, depending on the circumstance.

In ILP mode the caches of the two processors become logically conjoined into a larger cache by considering one of them to be “even” and the other “odd” on whatever access granularity is desired. In this way, the effectively wider superscalar processor comprises two halves, where one half decodes and dispatches the even-address instructions, and the other decodes and dispatches the odd-address instructions. Any dispatched instruction can be executed by either halt and the SROB keeps track of which instructions are where, and which are ready to execute.

Each of the original simpler processors can be envisioned as “in-order” cores that do not necessarily require “ReOrder Buffers” (ROBs). The SROB is a structure designed for use in ILP mode. However, a case could be envisioned in which each of the original processors is also an out-of-order processor having its own ROB, and then conjoining the ROBs into an SROB when in ILP mode.

Basic SROB entry is no more complex than the original ROB entry. Therefore, SROB may comprise roughly twice as many entries because there can be twice as many instructions in flight in the conjoined processor in ILP mode than, for example, for either processor when in TLP mode. Thus, “making a SROB” may be achieved by concatenating the original two ROBs.

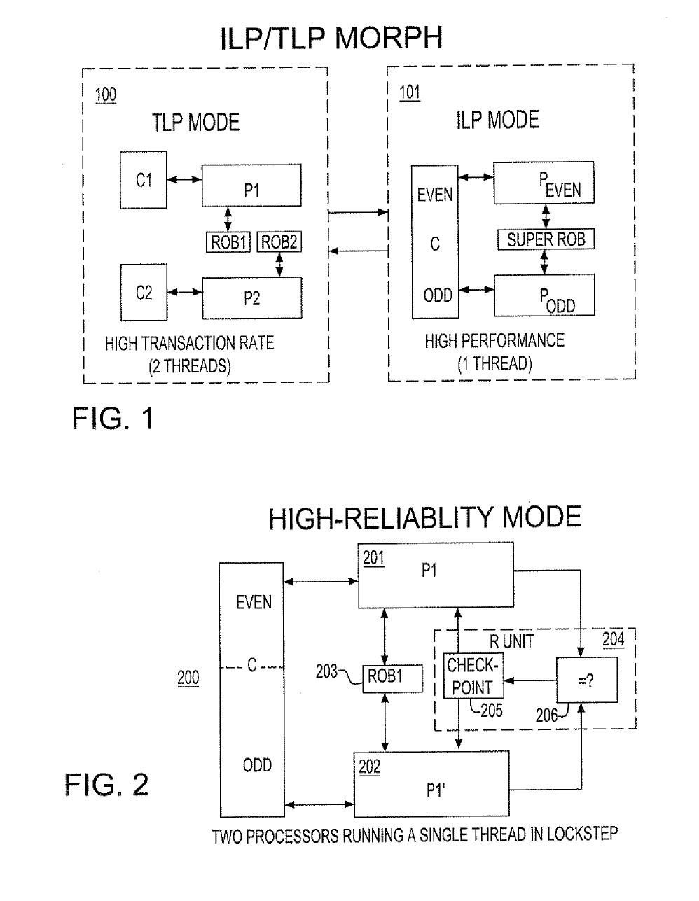

FIG. 1 shows the ILP/TLP morph in accordance with Sathaye. In TLP mode (100), the two processors are not coupled, and they independently run separate instruction streams, each from their own cache, with each managed by its own ROB. This mode may pertain to in-order processors that do not require a ROB.

In ILP mode (101) the two caches are conjoined into a single logical cache having an even and an odd side (by address), and the two ROBs are conjoined as well into an SROB, twice as long. Physically, nothing need change, but logically, the two caches become a single cache that is twice as big, and the two ROBs become a single SROB that is twice as big.

There may be a requirement that a ROB entry (containing bookkeeping information about an active instruction) must (roughly) be 10 bytes wide, and that the number of entries per ROB should be 4-6 times the number of pipeline stages. Thus, for a 6-10 stage pipeline, the number of entries per ROB may be 32-64, and the SROB will have twice this many, since it is a concatenation of two ROBs.

An embodiment of the present invention takes advantage of these dimensions. Specifically, a 10-byte entry in the ROB is adequate for holding two words with full ECC, which would correspond to a checkpointed register pair in the R-Unit of U.S. Pat. No. 5,692,121. It is advantageous to store checkpointed registers in pairs, since the two register contents can be bit-wise interleaved to provide additional protection against events in which a pair of adjacent bits is disturbed. If this occurs then each of the two adjacent bits is logically part of a different register, hence the two bits are each protected within independent ECC codewords, i.e., both of the resulting errors are correctable.

Therefore, a single ROB containing 32-64 entries is capable of checkpointing 64-128 register values, each with ECC, and it is capable of storing them in pairs without any special rearrangement of the wiring. This size (64-128 registers) turns out to be adequate for the architected state of many ISAs, which have 32-64 architected registers, plus miscellaneous other architected state bits (control registers, program counter, condition codes, etc.). Therefore, a ROB can be “transformed” into an R-Unit checkpoint array by simply using it as such.

FIG. 2 shows “High-Reliability” morphing mode in one embodiment of the present disclosure. In the figure, the two caches are logically conjoined into a single cache (200), which has twice the capacity of either half. The two processors (201 and 202) run the same program—in lockstep—under control of a single ROB (203). The cache is protected with parity, and is a store-through cache, so that no soft-error in the cache can cause the system to crash. Instead, parity errors on cache accesses are treated as misses. Any errors in the processors will be detected, since the processors are redundant with respect to one another.

Operating the two caches as a single (twice as large) cache (having an even half and an odd half) just as is done in ILP mode provides for additional performance capabilities. That is, by using the cache as it would be used in ILP mode, it delivers more performance. It allows the pair of processors to have the performance of a single processor having a cache that is twice as large.

In HR mode, fill error detection is achieved in either processor and fill recovery from those errors with an R-Unit (204) in accordance with the teachings of U.S. Pat. No. 5,692,121, entire disclosure of which is incorporated herein by reference. To make the R-Unit (204), the second ROB (from TLP mode—which is not needed when both processors are running the same instructions in lockstep) is used as the checkpoint array (205). To complete the R-Unit, a simple comparison circuits (206) may be added, which compare the outputs of the two processors (201 and 202) on every attempted instruction completion.

If the compare logic (206) finds that the results match, then the inference is that there was no error in either processor, so one of the results is checkpointed in the checkpoint array (205) with ECC. If the results do not match, then there was an error in (at least) one of the processors, and the result is not checkpointed. Instead, all of the architected state in the checkpoint array is used to refresh all copies of that state in the two working processors, and processing resumes, starting with the instruction that failed to complete. In one embodiment, such recovery action cycles through all of the architected state stored in the checkpoint array, checking and correcting those values using the stored ECC, and refreshing all of the working copies of that state in both the processors using the values that were checkpointed.

Therefore, by adding comparison circuitry and by reinterpreting the geometry of an existing ROB so as to use it for a checkpoint array, a new “morphing mode” that provides highly reliable operation is enabled in the present application. In one embodiment, this new mode can work in conjunction with ILP mode, or in conjunction with TLP mode, or in conjunction with both.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. In a dual-processor system having a plurality of operating modes in which two independent processors can be conjoined into a single superscalar processor, a method for providing reliable computing, comprising:
using a reorder buffer of a first processor for a checkpoint array;
using a reorder buffer of a second processor to keep track of a plurality of instructions;
running the first processor and the second processor under control of the reorder buffer of the second processor;
comparing output of the first processor and the second processor;
if the output of the first processor and the second processor match, checkpointing the output in the reorder buffer of a first processor used as a checkpoint array; and
if the output of the first processor and the second processor do not match, using one or more states in the reorder buffer of a first processor used as a checkpoint array to refresh one or more states in the first processor and the second processor.

2. The method of claim 1, wherein the step of checkpointing includes at least storing results of every instruction and associated error control codes in the reorder buffer of a first processor used as a checkpoint array.

3. The method of claim 1, wherein the step of checkpointing includes at least checkpointing registers of the reorder buffer of a first processor used as a checkpoint array in pairs, the pairs being bit-interlaced to provide protection against one or more events that cause multiple bit upset.

4. In a dual-processor system having a plurality of operating modes in which two independent processors can be conjoined into a single supersealar processor, a system for providing reliable computing, comprising:
a reliability unit provided for a processor pair, the reliability unit including at least:
a reorder buffer of a first processor in the processor pair operable for use as checkpoint array;
a comparison logic operable to compare one or more results of every instruction completed by the processor pair; and
an error control codes generation logic operable to generate error control code for the one or more results.

5. The system of claim 4, wherein the reliability unit is operable to store in the checkpoint array the one or more results of every instruction and associated error control code, if it is determined by the comparison logic that the processor pair has the same result from executing an instruction; and
the reliability unit is further operable to initiate a recovery action if it is determined by the comparison logic that the processor pair does not have the same result from executing an instruction.

6. The system of claim 4, wherein the reliability unit is operable to store checkpointed registers in pairs, the pairs being bit-interlaced.
